(19) United States
(12) Patent Application Publication
(10) Pub. No.: US 2007/0064117 A1
(43) Pub. Date: Mar. 22, 2007

(54) Image signal processing circuit and imaging unit using the same

(76) Inventors: Tomomichi Nakai, Osaka (JP); Toshio Nakakuki, Osaka (JP)

Correspondence Address: HOGAN & HARTSON L.L.P., 1999 AVENUE OF THE STARS, SUITE 1400, LOS ANGELES, CA, 90067, US

(21) Appl. No.: 10/534,420

(22) PCT Filed: Nov. 10, 2003
(86) PCT No.: PCT/JP03/14256

§ 371 Date: Aug. 9, 2006

(30) Foreign Application Priority Data
Aug. 11, 2002 (JP) 2002-325274

(51) Int. Cl. H04N 5/228

(52) U.S. Cl. 348/222.1

(57) ABSTRACT

A first solid state imaging device (20a) captures a first picture of a subject to generate a first image signal Ya(t). A second solid state imaging device (20b) captures a second picture of the subject to generate a second image signal Yb(t). In synchronization with operation of the first and second solid state imaging devices (20a, 20b), a selection circuit (26) alternately selects one of the first and second image signals Ya(t) and Yb(t) to output a selected image signal. A digital processing circuit (29) includes a first register (33a) that stores first exposure data EDa generated in accordance with the first image signal Ya(t), and includes a second register (33b) that stores second exposure data EDb generated in accordance with the second image signal Yb(t). This enables smooth switching of operation between the solid state imaging devices.

### 1. TECHNICAL FIELD

The present invention relates to an image signal processing circuit and an imaging unit using the same, in which a plurality of solid state imaging devices are used to capture a plurality of pictures of a subject, and to which a plurality of sequences of thus obtained image signals are input alternately.

### 2. BACKGROUND ART

Developments are being made in the field of an imaging unit, such as a digital camera or a digital video camera, so that a plurality of solid state imaging devices are incorporated to capture a plurality of pictures of a subject and a plurality of sequences of thus obtained image signals are combined for display on a common display screen (for example, refer to Japanese Patent Laid-Open Publication No. Sho 64-62974). With such a unit, a three-dimensional picture or the like can be obtained.

Such an imaging unit has, for example, a structure as shown in FIG. 6, in which a first solid state imaging device 1a, a first driving circuit 2a, and a first signal processor circuit 4a are provided to form a first imaging sequence, and in which a second solid state imaging device 1b, a second driving circuit 2b, and a second signal processor circuit 4b are provided to form a second imaging sequence. In addition, a synchronization signal generator circuit 3, a selection circuit 5, and a third signal processor circuit 6 are provided as shared circuits.

In the imaging unit shown in FIG. 6, the first and second driving circuits 2a and 2b respectively drive the first and second solid state imaging devices 1a and 1b in response to a timing signal generated from the synchronization signal generator circuit 3, and two sequences of image signals output from the first and second solid state imaging devices 1a and 1b are input to the first and second signal processor circuits 4a and 4b, respectively. The first and second signal processor circuits 4a and 4b perform processing such as gamma correction and AGC (automatic gain control) on the respective sequences of image signals, and output the processed signals to the selection circuit 5. The selection circuit 5 receives the two sequences of image signals through respective input terminals, and alternately selects one of the received signals to output a selected image signal to the third signal processor circuit 6. The third signal processor circuit 6 performs processing such as color separation and matrix operation on the image signal selected in the selection circuit 5, and generates an image signal containing a luminance signal and a color difference signal.

In such an imaging unit, two sequences of image signals from the first and second solid state imaging devices are selected alternately to generate one sequence of image signal in which the first and second image signals are arranged alternately at predetermined intervals.

Because an imaging unit as described above is provided with a plurality of solid state imaging devices, in order to obtain a proper image signal, it is necessary to individually perform processing such as exposure control to control the amount of exposure of a solid state imaging device and white balance processing to correct white balance of an image signal.

Although it is possible to employ a method in which signal processing circuits of a number equal to the number of imaging sequences are provided for use in exposure control and white balance processing, such a method is undesirable in cases where downsizing of an entire imaging unit is strongly desired. In particular, in recent years, some imaging units of a type incorporated in compact portable equipment are coming into wide use. Because downsizing is a major concern in an imaging unit of this type, it is preferable to share the use of an exposure control circuit and a white balance control circuit among a plurality of imaging sequences.

In such an arrangement sharing the use of signal processing circuits, when the operation of solid state imaging devices is switched, settings of exposure control and white balance processing for a solid state imaging device that has been operating until then are used as initial values for settings of exposure control and white balance processing for a solid state imaging device that starts operating. As a result, the settings of exposure control and white balance processing used immediately after the switching of operation undergo extreme changes, which cause inconvenient situations in which no proper image signal can be obtained, or in which a long period of time is needed to obtain a proper image signal.

An objective of the present invention is to provide an image signal processing circuit and an imaging unit in which, when operation is switched between solid state imaging devices, a proper image signal can be obtained quickly, and the switching of operation can be performed smoothly.

### 3. DISCLOSURE OF INVENTION

According to one aspect of the present invention, there is provided an image signal processing circuit that controls an amount of exposure for each of first and second solid state imaging devices that operate in a time-division manner, the processing circuit comprising an exposure control section that generates first and second exposure data, each of which indicates an amount of exposure for one of the first and second solid state imaging devices, so that a value of each of first and second image signals output from the first and second solid state imaging devices falls within predetermined limits, wherein the exposure control section includes a first memory section that stores the first exposure data, and a second memory section that stores the second exposure data.

According to another aspect of the present invention, there is provided an imaging unit comprising a first solid state imaging device having a plurality of light receiving pixels that accumulate information charges generated in response to a first picture of a subject, a first driving circuit that drives the first solid state imaging device to obtain a first image signal, a second solid state imaging device having a plurality of light receiving pixels that accumulate information charges generated in response to a second picture of the subject, a second driving circuit that drives the second solid state imaging device to obtain a second image signal, a selection circuit that receives the first and second image signals to selectively output one of the received image signals in synchronization with timing of operation of the first and second solid state imaging devices, and an exposure control circuit that generates first and second exposure data, each of which indicates an amount of exposure for one of the first and second solid state imaging devices, so that a value of each of the first and second image signals output from the first and second solid state imaging devices falls within predetermined limits, wherein the exposure control circuit includes a first memory section that stores the first exposure data, and a second memory section that stores the second exposure data.

According to the present invention, while the use of a signal processing circuit that generates exposure data is shared, it is possible to store first exposure data associated with a first solid state imaging device and second exposure data associated with a second solid state imaging device, respectively and independently.

As a result, when operation is switched between the solid state imaging devices, because exposure data for a solid state imaging device that has been operating until immediately before the switching ceases to be used, and exposure data held in a memory section can be used, the switching of operation can be performed smoothly.

According to still another aspect of the present invention, there is provided an image signal processing circuit that corrects white balance by applying predetermined gains to each of first and second image signals output from first and second solid state imaging devices that operate in a time-division manner, the processing circuit comprising a white balance processing section that generates first and second gain data, each of which indicates amounts of gains for one of the first and second image signals, wherein the white balance processing section includes a first memory section that stores the first gain data, and a second memory section that stores the second gain data.

According to still another aspect of the present invention, there is provided an imaging unit comprising a first solid state imaging device having a plurality of light receiving pixels that accumulate information charges generated in response to a first picture of a subject, a first driving circuit that drives the first solid state imaging device to obtain a first image signal, a second solid state imaging device having a plurality of light receiving pixels that accumulate information charges generated in response to a second picture of the subject, a second driving circuit that drives the second solid state imaging device to obtain a second image signal, a selection circuit that receives the first and second image signals to selectively output one of the received image signals in synchronization with timing of operation of the first and second solid state imaging devices, and a white balance processing circuit that corrects white balance by applying predetermined gains to each of the first and second image signals, wherein the white balance processing circuit includes a first memory section that stores first gain data that indicates amount of gain to be applied to the first image signal, and a second memory section that stores second gain data that indicates amount of gain to be applied to the second image signal.

According to the present invention, while the use of a signal processing circuit that corrects white balance is shared, it is possible to store first gain data for use in correcting white balance associated with a first solid state imaging device and second gain data associated with a second solid state imaging device, respectively and independently.

As a result, when operation is switched between the solid state imaging devices, because gain data for use in correcting white balance associated with a solid state imaging device that has been operating until immediately before the switching ceases to be used, and gain data held in a memory section can be used, the switching of operation can be performed smoothly.

### 4. BRIEF DESCRIPTION OF DRAWINGS

FIG. 1 is a block diagram showing a structure of a preferred embodiment of the present invention.

FIG. 2 is a block diagram showing an example of a structure of an exposure control section 32.

FIG. 3 is a timing chart illustrating operation of the exposure control section 32 of FIG. 2.

FIG. 4 is a block diagram showing an example of a structure of a white balance processing section 34.

FIG. 5 is a timing chart illustrating operation of the white balance processing section 34 of FIG. 4.

FIG. 6 is a block diagram showing a structure of a conventional imaging unit.

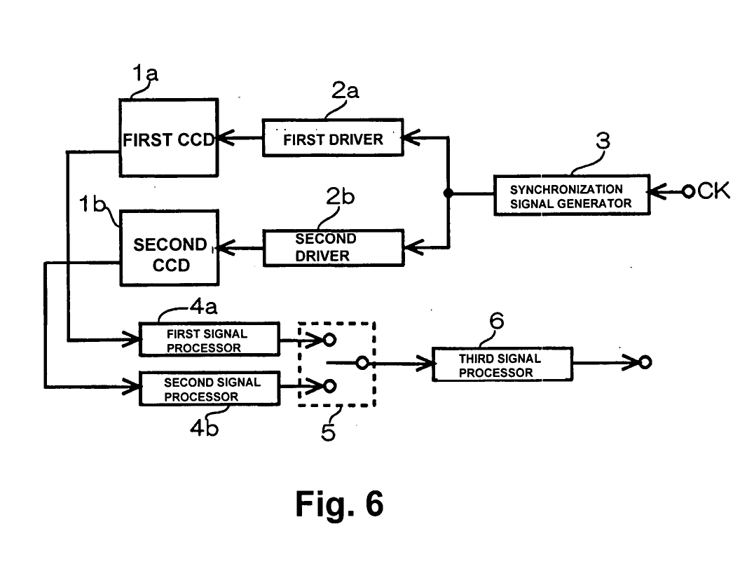

### 5. BEST MODE FOR CARRYING OUT THE INVENTION

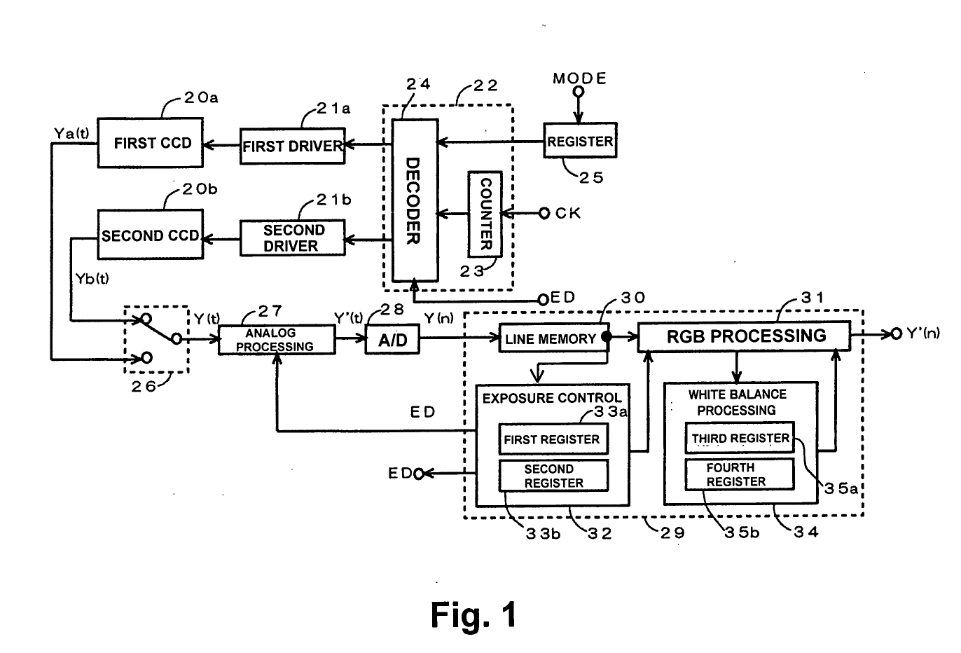

FIG. 1 is a block diagram showing a general structure of a preferred embodiment of the present invention, and shows a block structure of an entire imaging unit. The imaging unit shown in FIG. 1 includes a first solid state imaging device 20a, a first driving circuit (driver) 21a, a second solid state imaging device 20b, a second driving circuit (driver) 21b, a timing control circuit 22, a selection circuit 26, an analog processing circuit 27, an A/D conversion circuit 28, and a digital processing circuit 29. In this example, the first solid state imaging device 20a and the second solid state imaging device 20b are provided in the form of CCDs, which are shown as a first CCD and a second CCD in the drawing.

The first solid state imaging device 20a includes a light receiving section having a plurality of light receiving pixels arranged in a matrix, in which each light receiving pixel accumulates a first information charge generated in response to reception of a first picture of a subject by the light receiving section. Such a solid state imaging device uses one of several different types of transfer mode, such as a frame transfer type in which information charges for one frame are transferred to an accumulation section at high speed, an interline type in which information charges accumulated in the light receiving section are transferred to a vertical transfer section located between columns of the light receiving pixels, and a frame interline type combining features of both the frame transfer type and the interline type.

The first driving circuit 21a is provided corresponding to the first solid state imaging device 20a to drive the first solid state imaging device 20a, from which a first image signal Ya(t) is output. The first driving circuit 21a generates a driving clock in response to a timing signal supplied from the timing control circuit 22, and outputs the driving clock to the first solid state imaging device 20a to drive the first solid state imaging device 20a. For example, when the first solid state imaging device 20a is of the frame transfer type, the first driving circuit 21a generates, as a driving clock, a frame transfer clock φf, a vertical transfer clock φv, a horizontal transfer clock φh, and a reset clock φr. The frame transfer clock φf is used to transfer a frame of information charges accumulated in the light receiving section to the accumulation section at high speed, and the vertical transfer clock φv is used to transfer a frame of information charges accumulated in the accumulation section to a horizontal transfer section in units of one row. The horizontal transfer clock φh is used to transfer a row of information charges accumulated in the horizontal transfer section to an output section in units of one pixel, and the reset clock φr is used to reset the output section in units of one pixel. In this manner, the first solid state imaging device 20a outputs the first image signal Ya(t) in units of one pixel.

The second solid state imaging device 20b and the second driving circuit 21b have structures substantially identical to those of the first solid state imaging device 20a and the first driving circuit 21a. The second solid state imaging device 20b accumulates, in a plurality of light receiving pixels, information charges generated in response to a second picture of a subject, and the second driving circuit 21b drives the second solid state imaging device 20b to output a second image signal Yb(t).

The timing control circuit 22 supplies a timing signal to the first and second driving circuits 21a and 21b, and determines vertical scanning timing and horizontal scanning timing for the first and second solid state imaging devices 20a and 20b. The timing control circuit 22 includes a counter 23 and a decoder 24, in which the counter 23 counts periodic reference clocks CK and the decoder 24 decodes an output from the counter 23 to generate a timing signal. In this step, the setting of the decoder 24 may be changed to generate various types of timing signal.

The timing control circuit 22 receives, from the digital processing circuit 29, exposure data that indicates an amount of exposure for each of the first and second solid state imaging devices 20a and 20b, and, in accordance with the received exposure data, the timing control circuit 22 generates a discharge timing signal that indicates electronic shutter timing for each of the first and second solid state imaging devices 20a and 20b. Each of the first and second driving circuits 21a and 21b, which receives the generated discharge timing signal, generates a discharge clock φb and supplies the discharge clock to each of the first and second solid state imaging devices 20a and 20b to reset information charges accumulated in the light receiving section. This reset timing is controlled so as to extend or shorten the time for accumulation of information charges to ensure an appropriate amount of exposure for each of the first and second solid state imaging devices 20a and 20b.

Further, the timing control circuit 22 also supplies a timing signal to circuits other than the first and second driving circuits 21a and 21b so that the operation of those circuits is synchronized with the operation timing of the first and second solid state imaging devices 20a and 20b.

A register 25 stores a plurality of sets of setting data that are respectively associated with a plurality of patterns of imaging modes, and, in response to an externally provided imaging mode switching signal MODE, the register 25 outputs to the timing control circuit 22 a set of the setting data corresponding to the imaging mode indicated by the imaging mode switching signal MODE. The imaging modes associated with the respective sets of setting data stored in the register 25 include, for example, a mode in which only either one of the first and second solid state imaging devices 20a and 20b is operated, and a mode in which the operation of the first and second solid state imaging devices 20a and 20b is switched for each frame or group of frames. The setting data corresponding to one of these imaging modes is supplied to the timing control circuit 22 so that each timing signal is changed according to the indicated imaging mode. For example, when the indicated imaging mode is such that the first and second solid state imaging devices 20a and 20b are operated alternately for each frame, the timing control circuit 22 supplies a timing signal only to a driving circuit corresponding to the solid state imaging device that is to be operated, and suspends the supply of a timing signal to the other driving circuit. After this, when acquisition of a frame of image signals from the operating solid state imaging device is completed, the driving circuit to which a timing signal is supplied is switched to operate the other solid state imaging device.

The selection circuit 26 receives the first and second image signals Ya(t) and Yb(t), and selects one of the first and second image signals Ya(t) and Yb(t) in synchronization with the operation timing of the first and second solid state imaging devices 20a and 20b to output a selected image signal Y(t). Thus, a sequence of image signal Y(t) in which the first and second image signals Ya(t) and Yb(t) are arranged alternately at predetermined intervals can be obtained.

The analog processing circuit 27 performs analog signal processing such as CDS and AGC on the image signal Y(t) output from the selection circuit 26. In CDS, which is performed on the image signal Y(t) in which a reset level and a signal level are repeated alternately, an image signal having a series of signal levels is generated by sampling a signal level after each reset level is clamped. Then, in AGC, the image signal sampled in the CDS is subjected to gain control such that an integral integrated with respect to one frame or one vertical scanning period falls within predetermined limits, and, in response to the exposure data output from the timing control circuit 29, a predetermined gain is provided to ensure that each of the first and second image signals Ya(t) and Yb(t) has an appropriate level.

The A/D conversion circuit 28 receives and normalizes the image signal Y′ (t) subjected to the analog signal processing, and converts the analog signal to a digital signal to output the resultant signal as image data Y(n).

The digital processing circuit 29 includes a line memory 30, an RGB processing section 31, an exposure control section 32, and a white balance processing section 34, and performs digital signal processing on the image data Y(n).

The line memory 30 stores an appropriate number of rows of image data Y(n) output from the A/D conversion circuit 28 in units of one line, and, after holding the image data for one horizontal scanning period, the line memory 30 outputs the image data to the RGB processing section 31 and the exposure control section 32.

The RGB processing section 31 performs processing such as color separation and matrix operation on the image data Y (n), and generates image data Y′ (n) containing luminance data and color difference data. For example, in color separation processing, the image data Y(n) is separated in accordance with the arrangement of colors of the first and second solid state imaging devices 20a and 20b to generate a plurality of items of color component data R(n), G(n), and B(n). In matrix operation processing, the respective items of the separated color component data are combined at a predetermined ratio to generate luminance data, and the luminance data is subtracted from the color component data R(n) and B(n) to generate color difference data.

The exposure control section 32 integrates the image data Y(n) in units of, for example, one frame or one vertical scanning period to generate integrated data, and generates exposure data ED such that the integrated data falls within predetermined limits which are determined in accordance with an appropriate amount of exposure. The exposure data ED is supplied to the timing control circuit 22, the analog processing circuit 27, and the RGB processing section 31 as data that indicates an amount of exposure for each of the first and second solid state imaging devices 20a and 20b. The exposure data ED is used to control the electronic shutter timing of the solid state imaging devices, the analog gain in AGC, and the digital gain to the image data Y(n).

Further, the exposure control section 32 has a first register 33a and a second register 33b, in which the first register 33a stores first exposure data EDa generated in accordance with image data obtained by converting a first image signal Ya(n) into a digital signal, and the second register 33b stores second exposure data EDb generated in accordance with image data obtained by converting a second image signal Yb(n) into a digital signal. Each of the registers 33a and 33b consists, for example, of a combination of a plurality of flip-flops, and is configured to allow storage of a predetermined number of bits of data.

Thus, by storing the first and second exposure data EDa and EDb in respective different storage areas, while the use of the exposure control section 32 is shared, it is possible to generate the first and second exposure data EDa and EDb respectively and independently. In other words, when the operation is switched between the solid state imaging devices, exposure data for a solid state imaging device that has been operating until immediately before the switching ceases to be used, and exposure data held in one of the first register 33a and the second register 33b can be used as an initial value to start operation. For example, when the solid state imaging device to be used is switched from the first solid state imaging device 20a to the second solid state imaging device 20b, the second exposure data EDb, which is held in the second register 33b while the operation of the second solid state imaging device 20b is suspended, can be used as an initial value to start operation.

The white balance processing section 34 integrates the color component data R(n), G(n), and B(n) output from the RGB processing section 31 in units of, for example, one frame or one vertical scanning period to generate color integrated data R′ (n), G′ (n), and B′ (n). Then, gains are applied to the color component data R(n) and B(n) to correct the white balance so that the color integrated data R′ (n), G′ (n), and B′ (n) become equivalent to each other.

Further, the white balance processing section 34 has a third register 35a and a fourth register 35b, in which the third register 35a stores first gain data GDa that indicates the amount of gain to be applied to color component data Ra(n) and Ba(n) obtained from the first image signal Ya(t), and the fourth register 35b stores second gain data GDb that indicates the amount of gain to be applied to color component data Rb(n) and Bb(n) obtained from the second image signal Yb(t).

Thus, similarly to the exposure control section 32, the white balance processing section 34 is also configured to store the first and second gain data GDa and GDb in respective different storage areas. Therefore, while the use of the white balance processing section 34 is shared, it is possible to generate the first and second gain data GDa and GDb respectively and independently. As a result, for example, when the solid state imaging device to be used is switched from the first solid state imaging device 20a to the second solid state imaging device 20b, the second gain data GDb, which is held in the fourth register 35b while the operation of the second solid state imaging device 20b is suspended, can be used as an initial value to start operation.

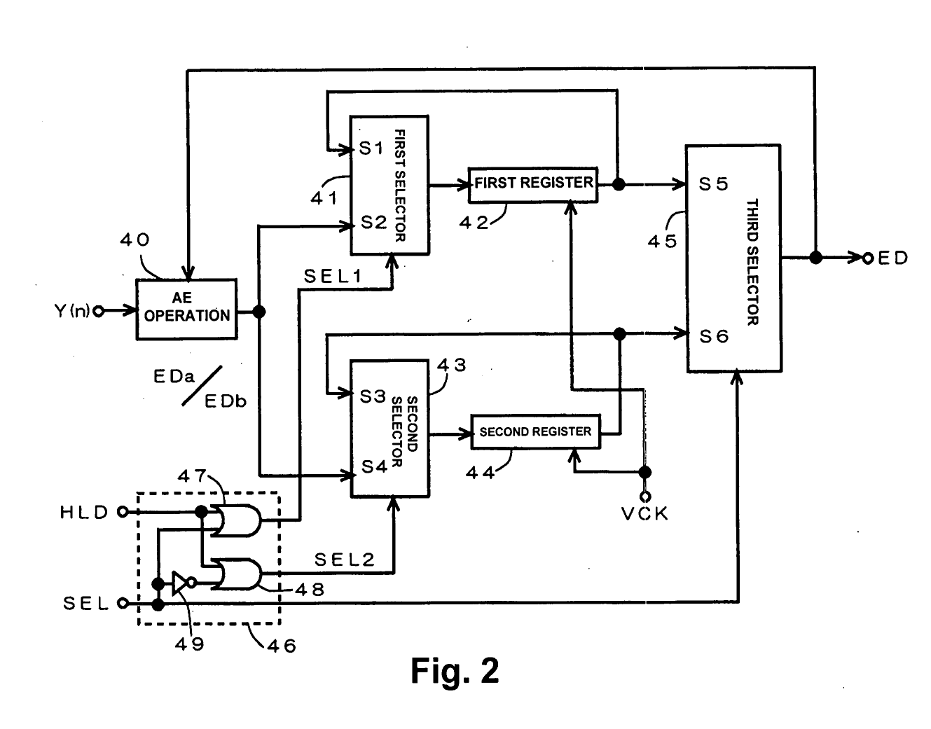

FIG. 2 is a block diagram showing an example of a structure of the exposure control section 32. The exposure control section 32 shown in FIG. 2 includes an exposure control operation (AE (automatic exposure) operation) circuit 40, a first selector 41, a first register 42, a second selector 43, a second register 44, a third selector 45, and a switch timing circuit 46.

The exposure control operation circuit 40 performs predetermined operation processing on the image data Y(n) to generate the first and second exposure data EDa and EDb. The first exposure data EDa is generated when the first image data Ya(n) is input, and the second exposure data EDb is generated when the second image data Yb(n) is input. For use as the first and second exposure data EDa and EDb, for example, an integral of image data for one vertical period is applicable as it is, and a mean value of the integral is also applicable. In other words, when data indicating an integral of image data for one frame or one vertical period is provided, because exposure can be optimally adjusted based on that data, any specific type of value may be used as long as the data corresponds to such an integral. In this example, because the exposure data ED output from the third selector is fed back to the exposure control operation circuit 40, the first and second exposure data obtained in the previous calculation can be used as initial values to calculate first and second exposure data for the next exposure.

The first selector 41 receives an output from the first register 42 through an input terminal S1 and receives the first and second exposure data EDa and EDb from the exposure control operation circuit 40 through an input terminal S2 to selectively output one of the data coming through the input terminal S1 and the data coming through the input terminal S2 in response to a first selection signal SEL1. The first register 42 receives, stores, and outputs an output from the first selector 41 to the third selector 45. The first register 42 consists of a plurality of flip-flops that operate in response to a clock VCK synchronized with the vertical scanning period, and stores a predetermined number of bits of exposure data output from the first selector 41 in units of, for example, one vertical scanning period.

The second selector 43 receives an output from the second register 44 through an input terminal S3 and receives the first and second exposure data EDa and EDb through an input terminal S4 to selectively output one of the data coming through the input terminal S3 and the data coming through the input terminal S4 in response to a second selection signal SEL2. The second register 44 receives, stores, and outputs an output from the second selector 43 to the third selector 45. Similarly to the first register 42, the second register 44 consists of a plurality of flip-flops that operate in response to a clock VCK, and stores an output from the second selector 43 in units of, for example, one vertical scanning period. The third selector 45 receives an output from the first register 42 through an input terminal S5 and receives an output from the second register 44 through an input terminal S6 to selectively output one of the received outputs as the exposure data ED in response to a selection signal SEL.

The switch timing circuit 46 includes a first OR gate 47, a second OR gate 48, and an inverter 49. One input of the first OR gate 47 receives a hold signal HLD generated from the timing control circuit 22, and another input receives a selection signal SEL similarly generated from the timing control circuit 22. The first OR gate 47 performs a logical OR operation on the received signals to output a first selection signal SELL. One input of the second OR gate 48 receives the hold signal HLD, and another input receives an inverted signal of the selection signal SEL that is inverted by the inverter 49. The second OR gate 48 performs a logical OR operation on the received signals to output a second selection signal SEL2.

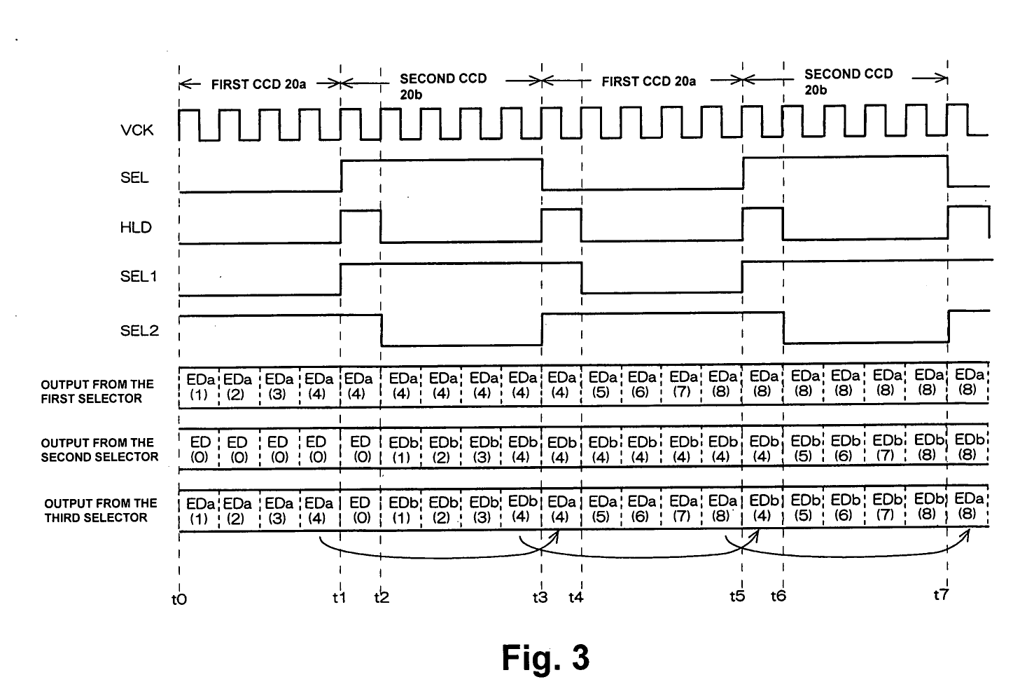

FIG. 3 is a timing chart illustrating operation of the exposure control section 32. This chart shows a case where the first solid state imaging device 20a operates for four vertical scanning periods from time t0 to time t1 and for five vertical scanning periods from time t3 to time t5, and the second solid state imaging device 20b operates for five vertical scanning periods from time t1 to time t3 and for five vertical scanning periods from time t5 to time t7. In this case, each of the first and second registers 42 and 44 stores predetermined initial data ED(0), from which the first exposure data EDa is successively updated for each vertical scanning period, as denoted as EDa (1), EDa(2) . . . and EDa(n), and from which the second exposure data EDb is successively updated for each vertical scanning period, as denoted as EDb(1), EDb(2) . . . and EDb(n).

First, in response to the start of operation of the first solid state imaging device 20a at time t0, the selection signal SEL is caused to fall to L level, and the first exposure data EDa is output from the exposure control operation circuit 40. In response to the level of the selection signal SEL, the first selection signal SEL1 is caused to fall to L level and the second selection signal SEL2 is caused to rise to H level. In response to this, the first selector 41 selects the input terminal S2 to output, to the first register 42, the first exposure data EDa output from the exposure control operation circuit 40. On the other hand, the second selector 43 selects the input terminal S3 to cancel the output from the exposure control operation circuit 40.

Then, the third selector 45 selects the input terminal S5 to output, to the next stage circuit, the output from the first register 42 as the exposure data ED, which is also fed back to the exposure control operation circuit 40. Such a state continues for four vertical scanning periods until time t1, and as a result, the first exposure data EDa input to the first register 42 is successively updated to vary from EDa(1) to EDa(4), which is output as the exposure data ED. Thus, by distributing the first and second exposure data EDa and EDb in accordance with the selection signal SEL, the first and second exposure data EDa and EDb can be stored in the first and second registers 42 and 44, respectively.

Next, at time t1, in response to switching of operation between the solid state imaging devices, the selection signal SEL is caused to rise to H level, and the exposure control operation circuit 40 starts to output the second exposure data EDb. In response to the level of the selection signal SEL, the third selector 45 is switched to select the input terminal S6. At the same time, the hold signal HLD is caused to rise in synchronization with the rise of the selection signal SEL, and, in response to this, the first and second selection signals SELL and SEL2 are caused to rise to H level. The hold signal HLD is caused to rise during, for example, one vertical scanning period from time t1 to time t2, and, as a result, the first and second selectors 41 and 43 respectively select the input terminals S1 and S3 for one vertical scanning period. Therefore, during the period from time t1 to time t2, the output from the exposure control operation circuit 40 is cancelled in both the first and second selectors 41 and 43.

Next, when the hold signal HLD is caused to fall to L level at time t2, the second selection signal SEL2 is caused to fall to L level. In response to this, the second selector 43 selects the input terminal S4, and outputs the second exposure data EDb to the second register 44. At this time, as the first selector 41 selects the input terminal S1, the first register 42 and the first selector 41 constitute a loop circuit.

Such a state continues for four vertical scanning periods from time t2 to time t3, and, as a result, the second exposure data EDb input to the second register 44 is successively updated to vary from EDb(1) to EDb(4), which is output as the exposure data ED.

In other words, the second exposure data varying from EDb(1) to EDb(4) calculated by the exposure control operation circuit 40 for each vertical period is successively stored in the second register 44, and is then output from the third selector 45 as the exposure data ED.

Further, during the same periods of time, the value EDa (4), that is, the first exposure data input immediately before the first solid state imaging device 20a stops operation, is continuously held in the loop circuit constituted by the first register 42 and the first selector 41, and as a result, the identical value is held throughout the periods.

Next, at time t3, when the operation is again switched between the solid state imaging devices, the selection signal SEL is caused to fall to L level, and the third selector 45 selects the input terminal S5. At the same time, as in the period from time t1 to time t2, the hold signal HLD is caused to rise to H level for one vertical scanning period from time t3 to time t4, and the first and second selection signals SEL1 and SEL2 are caused to rise to H level. As a result, the first and second selectors 41 and 43 cancel the output from the exposure control operation circuit 40, and the first exposure data EDa(4) held in the first register 42 is fed back to the exposure control operation circuit 40.

Thus, by canceling the exposure data ED generated in accordance with an image signal input immediately after the start of operation of a solid state imaging device, an unstable image signal input immediately after the start of operation is prevented from affecting generation of new exposure data ED. In this manner, it is possible to shorten the time necessary for the exposure data ED to converge to an appropriate value after the hold signal HLD falls, and thus the operation can be smoothly switched between the solid state imaging devices.

Next, when the hold signal HLD is caused to fall to L level at time t4, the first selection signal SELL is caused to fall to L level. In response to this, the first selector 41 selects the input terminal S2, and outputs the first exposure data EDa to the first register 42. At this time, as the value EDa(4) is held in the first register 42 as the first exposure data, the exposure control operation circuit 40 uses the first exposure data EDa(4) as an initial value. Then, after exposure control is initiated using the first exposure data EDa(4) as an initial value, during the periods from time t4 to time t5, the value of the first exposure data EDa is successively updated to vary from EDa(4) to EDa(8). Further, during the same periods of time, the second selector 43 selects the input terminal S4, and the second exposure data EDb(4) is held in the loop circuit constituted by the second register 44 and the second selector 43.

Thus, when the operation is switched between the solid state imaging devices, by using a value of the exposure data held during the periods of suspension of operation as an initial value for the exposure data associated with a solid state imaging device that starts operation, it is possible to more smoothly switch the operation between the solid state imaging devices. For example, when the first and second solid state imaging devices 20a and 20b respectively capture a subject in a fixed manner, because an adequate amount of exposure does not drastically change between before the operation suspends and after the operation restarts, by using the previously used exposure data as an initial value, the exposure data can be made to quickly converge to an appropriate value.

Next, during the period from time t5 to time t6, as in the period from time t3 to time t4, the hold signal HLD is caused to rise to H level, and the output from the exposure control operation circuit 40 is canceled. Then, the hold signal HLD is caused to fall to L level at time t6, the second selector 43 enables the output from the exposure control operation circuit 40 so that the second exposure data EDb is successively updated to vary from EDb(5) to EDb(8). Likewise, after time t7, in accordance with switching of operation between the first and second solid state imaging devices 20a and 20b, the above-described operation is repeated as in the periods from time t0 to time t7.

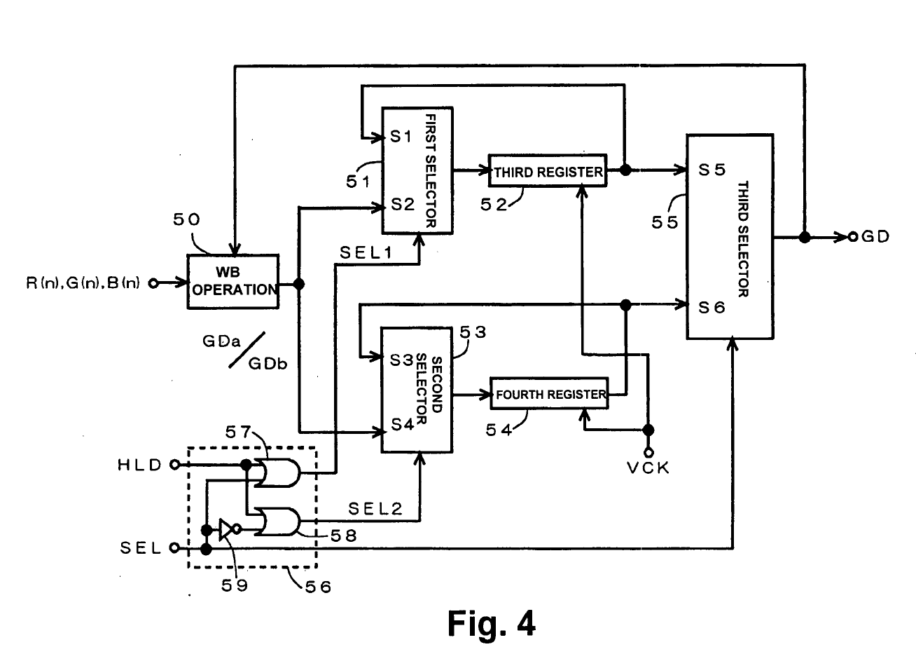

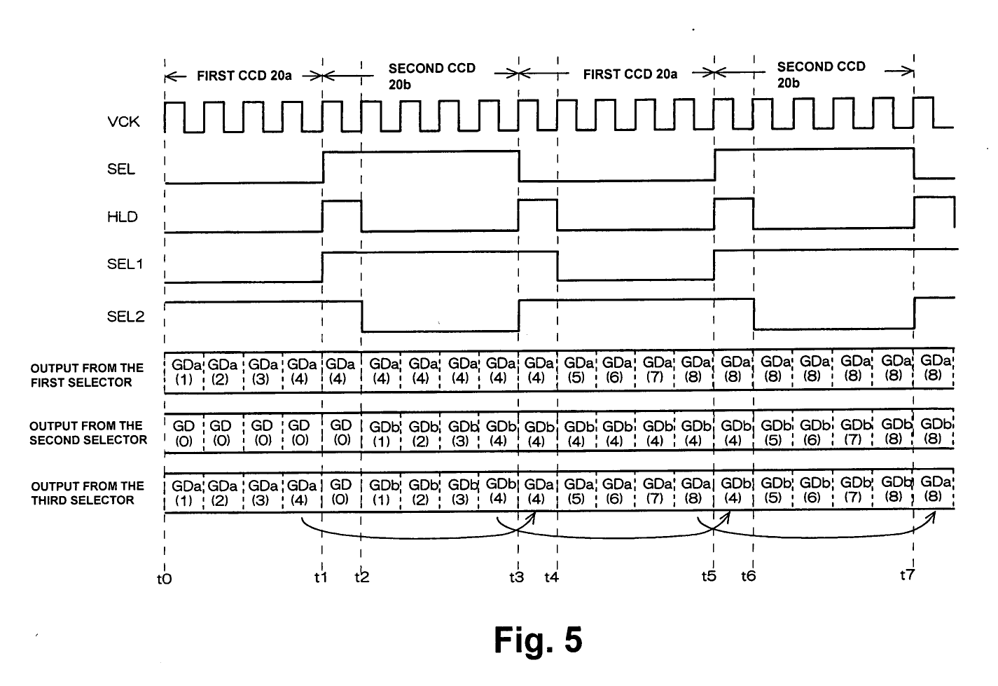

FIG. 4 is a block diagram showing an example of a structure of the white balance processing section 34, and FIG. 5 is a timing chart illustrating operation of the white balance processing section 34. Similarly to FIG. 3, FIG. 5 shows a case where the first solid state imaging device 20a operates for four vertical scanning periods from time t0 to time t1 and for five vertical scanning periods from time t3 to time t5, and the second solid state imaging device 20b operates for five vertical scanning periods from time t1 to time t3 and for five vertical scanning periods from time t5 to time t7. The first gain data GDa that is successively updated for each vertical scanning period is denoted as GDa (1), GDa(2) . . . and GDa(n), and the second gain data GDb that is successively updated for each vertical scanning period is denoted as GDb(1), GDb(2) . . . and GDb(n).

The white balance processing section 34 shown in FIG. 4 differs from the exposure control section 32 shown in FIG. 2 in that a white balance processing operation circuit 50 is used instead of the exposure control operation circuit 40. The white balance processing operation circuit 50 receives color component data R(n), G(n), and B(n) output from the RGB processing section 31, and performs predetermined operation processing such that the first gain data GDa is generated to indicate the amount of gain to be applied to the color component data Ba(n) and Ba(n) generated from the first image signal Ya(t), and such that the second gain data GDb(n) is generated to indicate the amount of gain to be applied to the color component data Rb(n) and Bb(n) generated from the second image signal Yb(t). Such white balance is used to adjust an amplification factor so that, when a white signal is input to the solid state imaging devices 20a and 20b, respective RGB color outputs for displaying white are of a predetermined ratio.

Other circuit elements are similar to those shown in FIG. 2. The first gain data GDa is stored in a third register 52, and the second gain data GDb is stored in a fourth register 54.

Further, as shown in FIG. 5, the white balance processing section 34 operates in a similar manner to the operation shown in FIG. 3. In accordance with switching of operation between the first and second solid state imaging devices 20a and 20b, one of the first and second gain data GDa and GDb is successively updated, and at the same time, the other data is held as it is. In addition, during the periods from time t1 to time t2, from time t3 to time t4, and from time t5 to time t6, the hold signal HLD is caused to rise so that the first and second selectors 51 and 53 cancel the output from the white balance processing operation circuit 50, and the values of the first and second gain data GDa and GDb input immediately before the timing of switching of operation are held for a predetermined period. Further, at time t3, and at time t4, a value of gain data held in one of the third and fourth registers 52 and 54 for the periods of suspension of operation is used as an initial value of gain data associated with a solid state imaging device that starts operation. By performing such operation, the operation of white balance (WB) processing can also be smoothly switched between the solid state imaging devices.

As described above, according to the present embodiment, while the use of a signal processing circuit that performs exposure control is shared, it is possible to generate the first exposure data EDa associated with the first solid state imaging device 20a and the second exposure data EDb associated with the second solid state imaging device 20b respectively and independently in synchronization with the periods of operation. Therefore, when the operation is switched between the solid state imaging devices, the setting of a device that has been operating until immediately before the switching is prevented from affecting the setting of a device that starts operation. Thus, a proper image signal can be obtained quickly, and the switching of operation can be performed smoothly between the solid state imaging devices.

### 6. INDUSTRIAL APPLICABILITY

The image signal processing circuit of the present invention and the imaging unit using the same are applicable to an imaging unit such as a digital video camera.

1. An image signal processing circuit that controls an amount of exposure for each of first and second solid state imaging devices that operate in a time-division manner, the processing circuit comprising:
an exposure control section that generates first and second exposure data, each of which indicates an amount of exposure for one of the first and second solid state imaging devices, so that a value of each of first and second image signals output from the first and second solid state imaging devices falls within predetermined limits, wherein the exposure control section includes:
a first memory section that stores the first exposure data; and
a second memory section that stores the second exposure data.

2. An image signal processing circuit according to claim 1, wherein, during a period when one of the first and second solid state imaging devices is operating, a value of one of the first and second exposure data is successively updated in accordance with an image signal obtained from the operating solid state imaging device, and a value of another one of the first and second exposure data is held without being updated.

3. An image signal processing circuit according to claim 2, wherein, when operation is switched between the first and second solid state imaging devices, the value of the exposure data that is held during the period of suspension of operation is used as an initial value to start operation.

4. An image signal processing circuit according to claim 2, wherein, when operation is switched between the first and second solid state imaging devices, the values of the first and second exposure data input immediately before a time of switching of operation are held for a predetermined period from the time of switching of operation.

5. An image signal processing circuit that corrects white balance by applying predetermined gains to each of first and second image signals output from first and second solid state imaging devices that operate in a time-division manner, the processing circuit comprising:
a white balance processing section that generates first and second gain data, each of which indicates amount of gain for one of the first and second image signals, wherein the white balance processing section includes:
a first memory section that stores the first gain data; and
a second memory section that stores the second gain data.

6. An image signal processing circuit according to claim 5, wherein, during a period when one of the first and second solid state imaging devices is operating, a value of one of the first and second gain data is successively updated in accordance with an image signal obtained from the operating solid state imaging device, and a value of another one of the first and second gain data is held without being updated.

7. An image signal processing circuit according to claim 6, wherein, when operation is switched between the first and second solid state imaging devices, the value of the gain data that is held during the period of suspension of operation is used as an initial value to start operation.

8. An image signal processing circuit according to claim 6, wherein, when operation is switched between the first and second solid state imaging devices, the values of the first and second gain data input immediately before time of switching of operation are held for a predetermined period from the time of switching of operation.

9. An imaging unit, comprising:
a first solid state imaging device having a plurality of light receiving pixels that accumulate information charges generated in response to a first picture of a subject;
a first driving circuit that drives the first solid state imaging device to obtain a first image signal;
a second solid state imaging device having a plurality of light receiving pixels that accumulate information charges generated in response to a second picture of the subject;
a second driving circuit that drives the second solid state imaging device to obtain a second image signal;
a selection circuit that receives the first and second image signals to selectively output one of the received image signals in synchronization with time of operation of the first and second solid state imaging devices; and
an exposure control circuit that generates first and second exposure data, each of which indicates an amount of exposure for one of the first and second solid state imaging devices, so that a value of each of the first and second image signals output from the first and second solid state imaging devices falls within predetermined limits, wherein the exposure control circuit includes:
a first memory section that stores the first exposure data; and
a second memory section that stores the second exposure data.

10. An imaging unit according to claim 9, wherein the first and second solid state imaging devices operate in a time-division manner, and wherein, during a period when one of the first and second solid state imaging devices is operating, the exposure control circuit successively updates a value of one of the first and second exposure data in accordance with an image signal obtained from the operating solid state imaging device, and holds a value of another one of the first and second exposure data without updating the value.

11. An imaging unit according to claim 10, wherein, when operation is switched between the first and second solid state imaging devices, the exposure control circuit uses, as an initial value to start operation, the value of the exposure data that is held during the period of suspension of operation.

12. An imaging unit according to claim 10, wherein, when operation is switched between the first and second solid state imaging devices, the exposure control circuit holds the values of the first and second exposure data input immediately before a time of switching of operation, for a predetermined period from the time of switching of operation.

13. An imaging unit, comprising:
a first solid state imaging device having a plurality of light receiving pixels that accumulate information charges generated in response to a first picture of a subject;
a first driving circuit that drives the first solid state imaging device to obtain a first image signal;
a second solid state imaging device having a plurality of light receiving pixels that accumulate information charges generated in response to a second picture of the subject;
a second driving circuit that drives the second solid state imaging device to obtain a second image signal;
a selection circuit that receives the first and second image signals to selectively output one of the received image signals in synchronization with time of operation of the first and second solid state imaging devices; and
a white balance processing circuit that corrects white balance by applying predetermined gains to each of the first and second image signals, wherein the white balance processing circuit includes:
a first memory section that stores first gain data that indicates amount of gain to be applied to the first image signal; and
a second memory section that stores second gain data that indicates amount of gain to be applied to the second image signal.

14. An imaging unit according to claim 13, wherein the first and second solid state imaging devices operate in a time-division manner, and wherein, during a period when one of the first and second solid state imaging devices is operating, the white balance processing circuit successively updates a value of one of the first and second gain data in accordance with an image signal obtained from the operating solid state imaging device, and holds a value of another one of the first and second gain data without updating the value.

15. An imaging unit according to claim 14, wherein, when operation is switched between the first and second solid state imaging devices, the white balance processing circuit uses, as an initial value to start operation, the value of the gain data that is held during the period of suspension of operation.

16. An imaging unit according to claim 14, wherein, when operation is switched between the first and second solid state imaging devices, the white balance processing circuit holds the values of the first and second gain data input immediately before a time of switching of operation, for a predetermined period from the time of switching of operation.
